(19) United States
(12) Patent Application Publication
(10) Pub. No.: US 2016/0253631 A1
(43) Pub. Date: Sep. 1, 2016

(54) SYSTEMS, METHODS, AND COMPUTER PROGRAMS FOR PROVIDING INTEGRATED CALENDAR/CONFERENCING WITH TARGETED CONTENT MANAGEMENT AND PRESENTATION

(71) Applicant: American Teleconferencing Services, Ltd., Atlanta, GA (US)

(72) Inventors: Boland Timothy Jones, Atlanta, GA (US); David Michael Guthrie, Atlanta, GA (US); Kaushal Kumar Panjwani, Dunwoody, GA (US); Therese Kristine Mushock, Atlanta, GA (US); Daniel Graff-Radford, Atlanta, GA (US)

(21) Appl. No.: 14/634,217

(22) Filed: Feb. 27, 2015

(51) Int. Cl. G06Q 10/10; G06F 3/0482; G06F 3/0485; G06F 3/0484

(52) U.S. Cl. CPC G06Q 10/1095; G06F 3/04842; G06F 3/0482; G06F 3/0485

(57) ABSTRACT

A computer system is disclosed for providing an integrated calendar/conferencing system. One such system comprises a conferencing system in communication with a server. The conferencing system establishes online conferences associated with a user having a corresponding user account comprising conference event data for one or more scheduled online conferences. The server comprises a user database and an event analysis component. The user database stores the user account and the conference event data. The event analysis component: obtains calendar event data from one or more remote application providers; and analyzes the calendar event data and the stored conference event data and identifies matching custom content to be presented to the user. The server presents to a mobile calendar application an integrated view of the calendar event data and the conference event data with the matching custom content.

### BACKGROUND

Currently, there are a number of conference solutions for enabling people to conduct live meetings, audio conferences, video conferences, conferences, presentations, or other types of gatherings via the Internet, the public switched telephone network (PSTN), or other voice and/or data networks. Participants typically use a telephone, computer, or other communication device that connects to a conference system. The meetings typically include an audio component and a visual component, such as, a shared presentation, video, whiteboard, or other multimedia, text, graphics, etc. While these types of conference solutions have become an indispensable form of communication for many businesses and individuals, it remains difficult to manage and control scheduled conferences in a consistent and convenient manner.

With many individuals, organizations, and enterprises having a preference for one of the various available conferencing solutions, it can be problematic to manage and schedule conferences in an increasingly complicated landscape. This problem is further complicated with the various available software applications for managing calendars, events, contacts, conferences, customer relationships, etc. For example, it is not unusual for an individual user to manage personal contacts, corporate contacts, social network contacts, and customer contacts with different software applications, websites, or application service providers, while being forced to organize phone calls, conference calls, online conferences, and in-person meetings with these contacts across multiple conferencing tools.

Despite the many advantages and commercial success of existing conferencing solutions, there remains a need in the art for improved systems, methods, and computer programs for managing conference and calendar events in a convenient manner.

### SUMMARY

Various embodiments of systems, methods, and computer programs are disclosed for providing an integrated calendar/conferencing system. One such system comprises a conferencing system and a server. The conferencing system is configured to establish online conferences associated with a user having a corresponding user account. The user account comprises conference event data for one or more scheduled online conferences. The server is in communication with the conferencing system and comprises a user database, an event analysis component, and a presentation component. The user database stores the user account and the conference event data for the one or more scheduled online conferences. The event analysis component is executed by a processor and comprises logic configured to: obtain calendar event data associated with the user from one or more remote application providers; and analyze the calendar event data and the stored conference event data associated with the user to identify matching custom content to be presented to the user. The presentation component is configured to provide the identified custom content to a mobile calendar application running on a portable communication device operated by the user. The mobile calendar application is configured to simultaneously display an integrated view of the calendar event data and the conference event data in a first display portion and a custom content area in a second display portion. The custom content area comprises the matching custom content corresponding to one or more of the calendar event data and the conference event data displayed in the first display portion.

Another embodiment is computer program embodied in a computer-readable medium and executed by a processor for providing an integrated calendar/conferencing service. The computer program comprises logic configured to: launch a mobile application and authenticate a user with a conferencing system via a communication network, the user having a user account comprising conference event data for one or more scheduled online conferences being managed and controlled by the conferencing system; determine a current portion of the conference event data to be displayed to the user via the mobile application; send a request to the conferencing system via the communication network for calendar event data associated with the user and corresponding to the current portion of the conference event to be retrieved by the conferencing system from one or more remote applications; in response to the request, receive from the conferencing system the corresponding calendar event data and targeted presentation content retrieved from a server database, the targeted presentation content selected to match one or more keywords identified from the current portion of the conference event data and the corresponding calendar event data; and display the current portion of the conference event data and the corresponding calendar event data as an integrated calendar/conference view in a first display portion of the mobile application and simultaneously display the matching targeted presentation content in a second display portion.

### BRIEF DESCRIPTION OF THE DRAWINGS

FIG. 1 is a block diagram illustrating an embodiment of an integrated calendar/conferencing system with targeted content management and presentation.

FIG. 2 is a combined block and data flow diagram illustrating the general architecture, operation, and functionality of an embodiment of the integrated calendar/conferencing system in FIG. 1.

FIG. 3 is a flowchart illustrating an embodiment of a method implemented by the integrated calendar/conferencing system of FIG. 1.

FIG. 4 is a user interface screen shot illustrating an embodiment of an integrated calendar/conference view displayed by a mobile calendar application in communication with the integrated calendar/conferencing system of FIG. 1.

FIG. 5 illustrates the user interface screen shot of FIG. 4 displaying updated targeted content in response to the user navigating to new calendar and/or conference event data.

FIG. 6 is a flowchart illustrating an embodiment of a method implemented by an exemplary portable communication device running the mobile calendar application.

### DETAILED DESCRIPTION

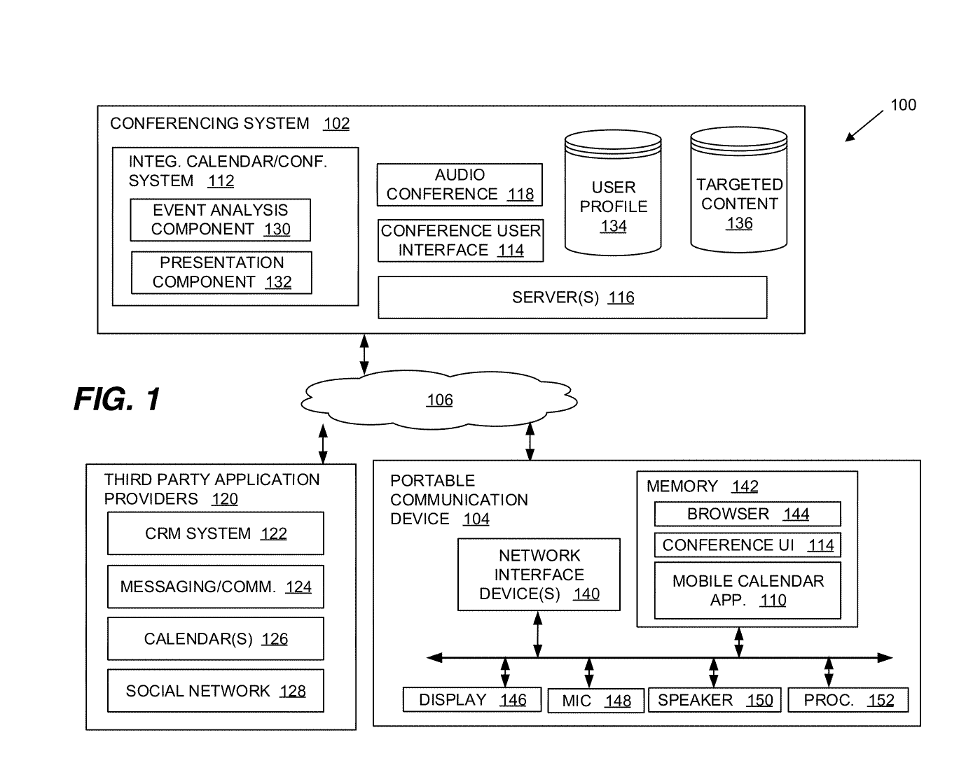

Various embodiments of systems, methods, and computer programs are disclosed for providing an integrated calendar/conferencing system with targeted content management and presentation. As described below in more detail with reference to FIGS. 1-6, the integrated calendar/conferencing system comprises a conferencing system that intelligently combines a user's native scheduled conferences and contacts (e.g., conferences, calendars, contacts, etc. which are stored or hosted by the conferencing system) with calendars, contacts, and other messaging and communication tools hosted by remote third party applications. The integrated calendar/conferencing system provides a smart mobile calendar application that displays both native data hosted by the conferencing system and remote data hosted by the third party applications. In this regard, the smart mobile calendar application may display all of a user's native and remote meetings in a combined user interface, as well as provide convenient, fast access to conference calls, web meetings, smart messaging to meeting invitees, customizable notifications, and integrations with various third party applications and services (e.g., customer relationship management (CRM) software-as-a-service (SaaS), social networking platforms, messaging/communication services, hosted calendar, contact, and/or cloud-based document storage applications, etc.).

The smart mobile calendar application automatically obtains conference information (e.g., dial-in numbers, passcodes, uniform resource locators (URLs) for online meetings, etc.) from the conferencing system and remote applications to enable the user to conveniently initiate telephone calls, conference calls, or web meetings directly from the application. The integrated calendar/conferencing system includes an analytics engine that analyzes the native and remote data to identify targeted content to be displayed to the user via the smart mobile calendar application. The targeted content may be selected based on calendar event data, scheduled online meeting data, agendas, locations, dates, participant or contact data, social networking data, or any other useful data stored by the conferencing system and/or accessible from the remote application providers. The targeted content may include, for example, corporate announcements, expert meeting tips, relevant information about scheduled meetings or participants, sponsored promotions, advertisements, product/service offerings, weather information, or news information.

FIG. 1 illustrates an embodiment of a computer system 100 for implementing an integrated calendar/conferencing system. The computer system 100 comprises a conferencing system 102 configured to communicate with a portable communication device 104 via one or more communication networks 106. The network(s) 106 may support wired and/or wireless communication via any suitable protocols and devices, including, for example, the Internet, the Public Switched Telephone Network (PSTN), cellular or mobile network(s), local area network(s), wide area network(s), or any other suitable communication infrastructure.

The portable communication device 104 may comprise any desirable computing device configured to communicate with the conferencing system 102 and server(s) 116 via the communication networks 106. In an embodiment, the portable communication device 104 may comprise a mobile computing device, a smart phone, a cellular telephone, a soft phone, a VoIP phone, a web-enabled electronic book reader, a tablet computer, gaming console, navigation device, or any other portable device capable of communicating with the conferencing system 102 and/or the server(s) 112 via one or more communication networks. As illustrated in FIG. 1, the portable communication device 104 may include client software (e.g., a browser 144, plug-in, or other functionality) configured to facilitate communication with the conferencing system 102 and the server 116. It should be appreciated that the hardware, software, and any other performance specifications of the portable communication device 104 are not critical and may be configured according to the particular context in which the device is to be used.

The portable communication device 104 may include network interface devices 140, a display 146, a microphone 148, a speaker 150, and a processor 152 for executing software and/or firmware associated with a memory 142. The networking interface devices 140 enable communication with the conferencing system 102 via communication networks 106. The microphone 148 and speaker 150 may be used for voice communications with the conferencing system 102 in an audio conference 118, a PSTN call, a VoIP call, a video conference, or other online conference established via the conferencing system 102. The online conference may be established, and provided via a conference user interface 114, such as described in U.S. patent application Ser. No. 12/789,993 entitled “Systems, Methods, and Computer Programs for Providing a Conference User Interface,” and filed on May 28, 2010, which is hereby incorporated by reference in its entirety. The conference user interface 114 may be displayed on the display 146. In an embodiment, the conferencing system 102 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be further appreciated that the conferencing system 102 may support various alternative platforms, technologies, protocols, standards, features, etc.

As further illustrated in FIG. 1, the conferencing system 102 may comprise one or more server(s) 116 that are configured to implement various functions of the conferencing system 102, such as, establishing an audio conference 118, an associated online conference, and for controlling presentation of the conference user interface 114 to portable communication device 104. As described below in more detail, the server(s) 116 may facilitate communications with one or more remote, third party applications 120. The third party applications 120 may comprise remote server(s), web services, hosted services, software-as-a-service (SaaS), or cloud-based applications. In the embodiment illustrated in FIG. 1, the remote applications comprise a CRM system 122, a messaging/communication platform 124, a social networking platform 128, and calendar applications 126. It should be appreciated that the remote applications may be programmatically accessed via an application program interface (API) or otherwise.

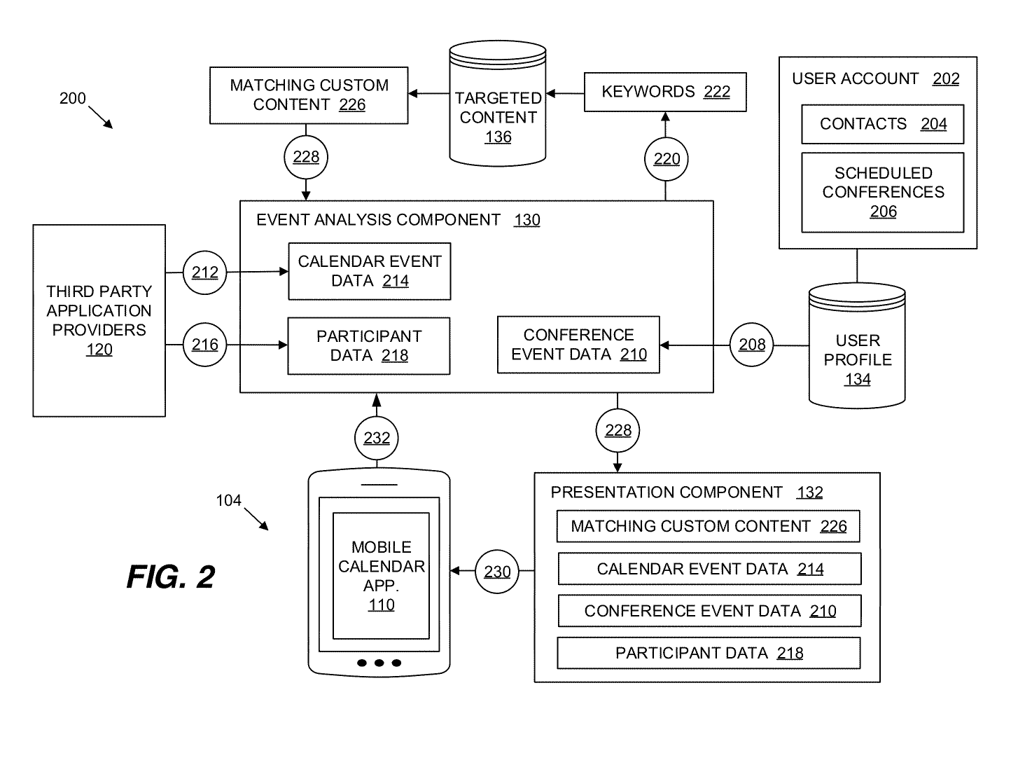

The conferencing system 102 may incorporate the integrated calendar/conferencing system 112, which generally comprises an event analysis component 130 and a presentation component 132. The event analysis component 130 and the presentation component 132 may be embodied in memory and executed by one or more processors. FIG. 2 illustrates an exemplary implementation of the event analysis component 130, the presentation component 132, the user profile database 134, and the targeted content database 136. At step 208, the event analysis component 132 may access the user profile database 134. The user profile database 134 stores user accounts 202 associated with registered users of the conferencing system 102. The user accounts 202 may store contacts 204 and scheduled conferences 206 for each user. The event analysis component 132 may access, for example, conference event data 210 associated with the scheduled conferences 206, participant data from contacts 204, or any other related data.

At steps 212 and 216, the event analysis component 132 may receive calendar event data 214 and participant data 218 from one or more of the third party application providers 120. The event analysis component 132 analyzes the remotely obtained calendar event data 214 and the natively stored conference event data 210. The analysis algorithms may be configured to identify relevant keywords 222 based on the combined calendar and conference data, as well as other relevant data, such as, participant data 218, meeting location data, and meeting dates and times. At step 220, the event analysis component 132 may perform a database look-up to a targeted content database 136 using the keywords 222 generated by the analysis algorithms. The targeted content database 136 comprises various types of content that may be presented to users via the mobile calendar application 110, including, for example, corporate announcements, expert meeting tips, relevant information about scheduled meetings or participants, sponsored promotions, advertisements, product/service offerings, weather information, or news information. The targeted content database 136 may be incorporated in the conference system 102 or accessed remotely from another service provider, web service, search engine, etc.

In response to a database query, custom content 226 may be identified that matches the keywords 222. At step 228, the custom content 226 (or links thereto) may be returned to the event analysis component 132. At step 228, the event analysis component 132 may communicate with the presentation component 132 to initiate presentation of the combined calendar event data 214 and conference event data 210, participant data 218, and the matching custom content 226 to the mobile calendar application 110 (step 230).

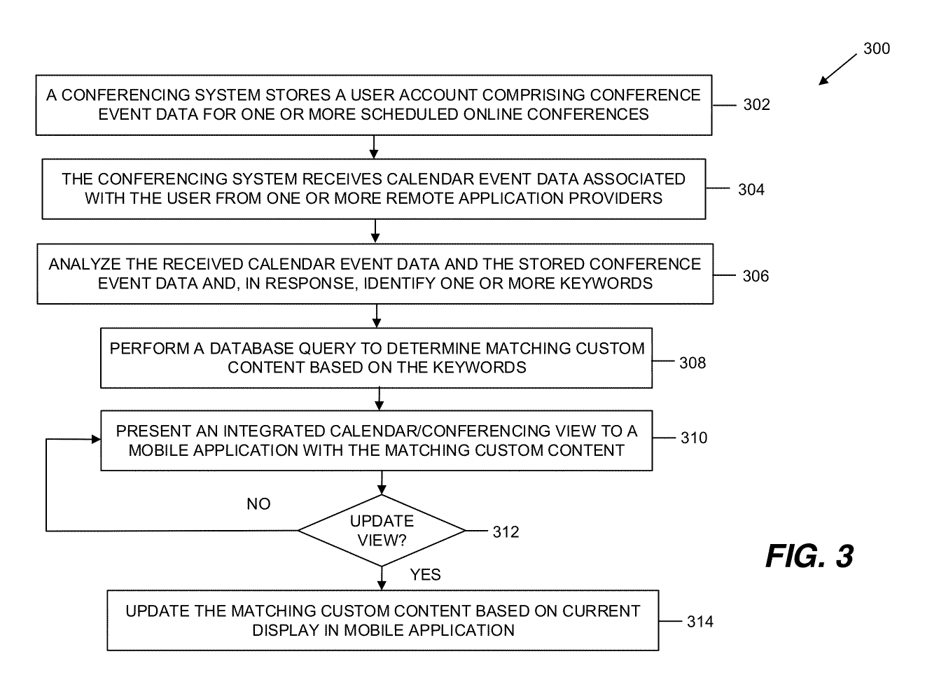

FIG. 3 illustrates an exemplary method 300 for implementing the integrated calendar/conferencing system. At block 302, the conferencing system 102 stores a user account 202 corresponding to a user. The user account 202 comprises conference event data 210 corresponding to one or more scheduled online conferences. At block 304, the conferencing system 102 receives calendar event data 214 associated with the user account 202 from one or more remote application providers 120. At block 306, the calendar event data 214 and the conference event data 210 are analyzed to identify one or more relevant keywords 222. As mentioned above, the keywords 222 may be identified based on other available data (e.g., contacts 204, participant data 218, dates, times, locations, etc.). At block 308, a query to target content database 136 is performed to determine matching custom content 226 based on the keywords 222. At block 310, the conferencing system 102 presents an integrated calendar/conferencing view to the mobile calendar application 110 with the matching custom content 226. The integrated calendar/conferencing view combines the native conference event data from the conferencing system 102 with the calendar event data from the remote applications 120.

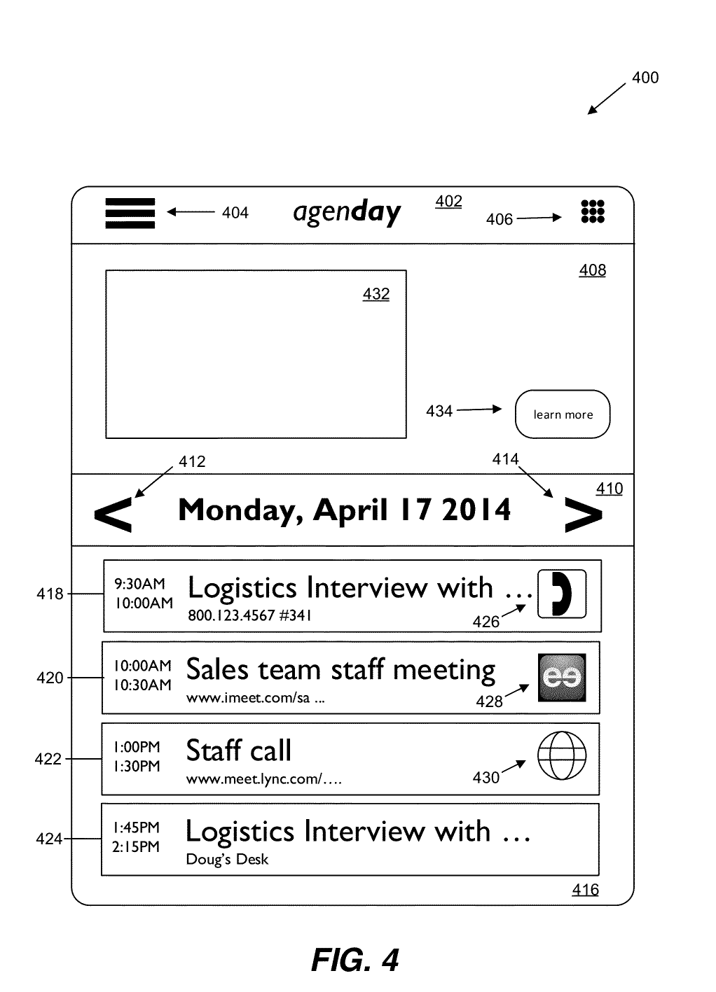

FIG. 4 illustrates an exemplary embodiment of an integrated calendar/conferencing view 400 displayed on a portable communication device 104 via the mobile calendar application 110. The integrated calendar/conferencing view 400 comprises a header bar 402, which includes a menu button 404 and a calendar button 406. When selected by a user, the menu button 404 may present various additional user selections for performing one or more of the following functions: schedule an event; enter a meeting; search for meetings; or configure application settings. The calendar button 406 exposes a calendar tool for enabling the user to switch the view to a particular date. An upper display portion 408 displays the matching custom content 226 (block 432) identified based on the keywords 222 “scraped” from the combined calendar event data 214 and conference event data 210 displayed in a lower display portion 416. The block 432 may comprise text, a graphical image, or other content. The matching custom content 226 may further comprise a button 434 for viewing additional information. The button 434 may be linked to a uniform resource locator (URL) for accessing a web page or other source via the Internet.

In the embodiment of FIG. 4, the lower display portion 416 displays four events 418, 420, 422, and 424 for the date identified in a navigation bar 410. Each event may display information, such as, the time, an event description, an event type, and if applicable a button for initiating the event directly from the mobile calendar application 110. Event 418 comprises a teleconference, and the corresponding button 426 may be selected to automatically initiate the teleconference based on a dial-in number and passcode. Event 420 comprises an online conference hosted by the conferencing system 102, and the corresponding button 428 may be selected to automatically initiate the online conference located at a particular URL. Event 422 comprises a meeting hosted by one of the remote applications 120, and the corresponding button 430 may be selected to automatically initiate the meeting with the third party provider.

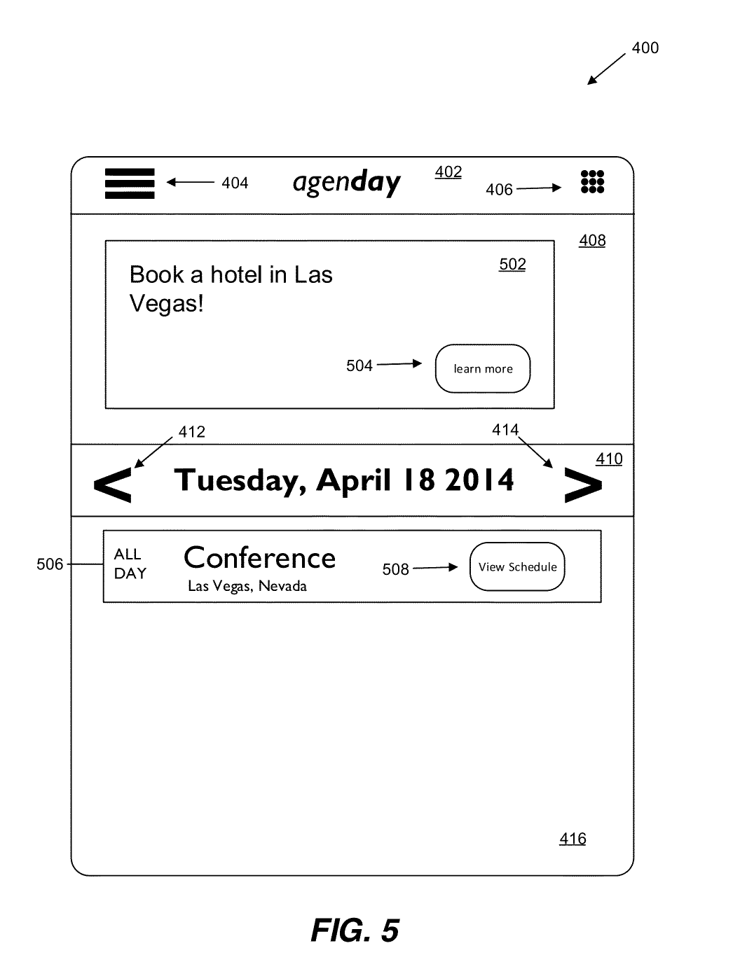

As illustrated in FIG. 4, the navigation bar 410 comprises buttons 412 and 414 for searching forward and backward, respectively, in the user's calendar. FIG. 5 illustrates the integrated calendar/conferencing view 400 after the user has selected the next day. In response to the new selection, the mobile calendar application 110 updates the view 400 (decision block 312-FIG. 3). Referring to again to FIG. 3, when the view 400 is updated to a new date, the conferencing system 102 may update the custom content 226 displayed in the upper display region 406 to match the new calendar event data 214 and/or conference event data 210 displayed in the lower display 416. In the example of FIG. 5, the new date comprises a calendar event 506 obtained from a remote calendar application for a conference located in Las Vegas, Nev. A button 508 may be selected to view the event details, schedule, etc. The new matching custom content 502 may comprise an advertisement to book a hotel in Las Vegas, Nev. The button 504 may be selected to access an associated URL for viewing the offer.

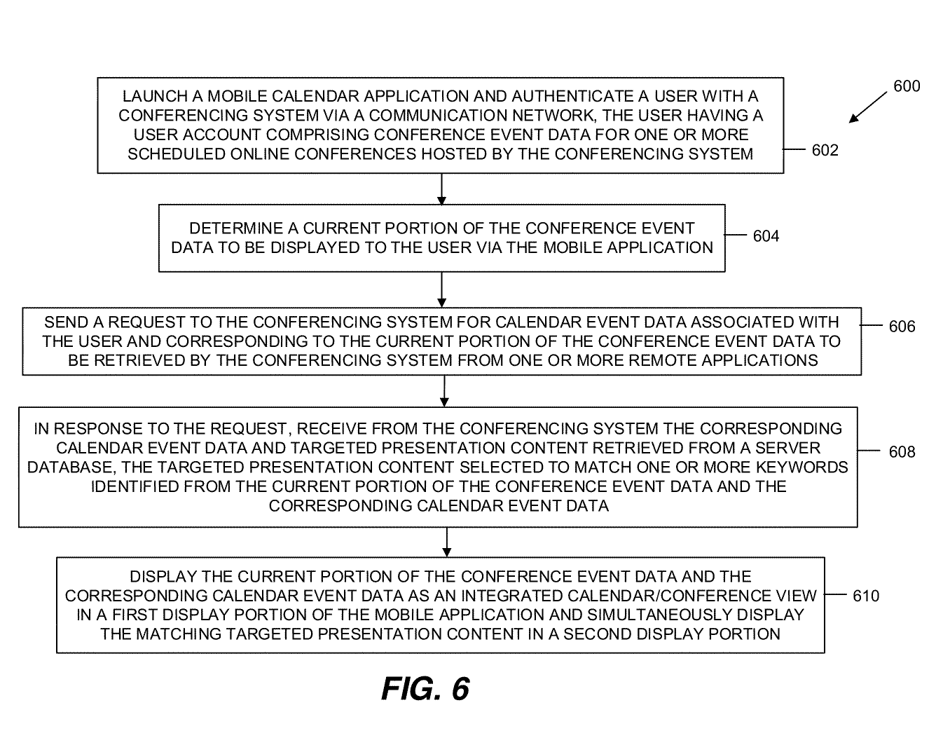

FIG. 6 illustrates an embodiment of a method 600 implemented by the mobile calendar application 110. At block 602, the user may launch the mobile calendar application 110 and, in response, the conferencing system 102 may authenticate the user account 202. At block 604, the mobile calendar application 110 determines a current portion of the conference event data 210 to be displayed to the user based on user selection via either the calendar button 406 or the navigation bar 410. In response, at block 606, a request may be transmitted to the conferencing system 102 for the corresponding calendar event data 214 from the one or more remote applications. In response to the request, at block 608, the mobile calendar application 110 may receive from the conferencing system 102 the corresponding calendar event data 214 and the matching custom content 226 retrieved from the targeted content database 136. At block 610, the mobile calendar application 110 displays the current portion of the conference event data 210 and the corresponding calendar event data 214 as an integrated calendar/conference view 400 while simultaneously displaying the matching custom content 226.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the computer system 100. Furthermore, the logical functions may be embodied in any computer readable medium for use by or in connection with an instruction execution system, apparatus, or device, such as a computer-based system, processor-containing system, or other system associated with the computer system 100 that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A computer system for providing an integrated calendar/conferencing system, the system comprising:
a conferencing system configured to establish online conferences associated with a user having a corresponding user account comprising conference event data for one or more scheduled online conferences; and
a server in communication with the conferencing system and comprising:
a user database for storing the user account and the conference event data for the one or more scheduled online conferences;
an event analysis component executed by a processor, the event analysis component comprising logic configured to:
obtain calendar event data associated with the user from one or more remote application providers;
analyze the calendar event data and the stored conference event data associated with the user to identify matching custom content to be presented to the user; and
a presentation component configured to provide the identified custom content to a mobile calendar application running on a portable communication device operated by the user, the mobile calendar application configured to simultaneously display an integrated view of the calendar event data and the conference event data in a first display portion and a custom content area in a second display portion, the custom content area comprising the matching custom content corresponding to one or more of the calendar event data and the conference event data displayed in the first display portion.

2. The computer system of claim 1, wherein the one or more remote application providers comprises one or more of a hosted calendar application, a social networking application, and a customer relationship management (CRM) application.

3. The computer system of claim 1, wherein the logic configured to analyze the calendar event data and the stored conference event data further comprises logic configured to:
identify one or more keywords based on a location, a date, or one or more participants associated with the calendar event data or the stored conference event data; and
selecting the matching custom content from a database based on the keywords.

4. The computer system of claim 3, wherein the matching custom content comprises one or more of an advertisement, a promotional offer, and a corporate announcement.

5. The computer system of claim 1, wherein the matching custom content is obtained from one of a social networking site, a search engine, and a third party advertisement platform.

6. The computer system of claim 1, wherein the matching custom content displayed in the second display portion comprises an image.

7. The computer system of claim 1, wherein the logic configured to analyze the calendar event data and the stored conference event data associated with the user to identify matching custom content further comprises: logic configured to determine a uniform resource locator (URL).

8. A method for providing an integrated calendar/conferencing service via a computer network, the method comprising:
a conferencing system storing a user account comprising conference event data for one or more scheduled online conferences;
receiving calendar event data associated with the user from one or more remote application providers;
analyzing the received calendar event data and the stored conference event data associated with the user and, in response, selecting matching custom content from a database to be presented to the user; and
presenting an integrated calendar/conferencing view to a mobile application running on a portable communication device operated by the user, the integrated calendar/conferencing view simultaneously displaying the calendar event data received from the one or more remote application providers and the conference event data in a first display portion and a custom content area in a second display portion, the custom content area comprising the matching custom content corresponding to one or more of the calendar event data and the conference event data displayed in the first display portion.

9. The method of claim 8, wherein the one or more remote application providers comprises one or more of a hosted calendar application, a social networking application, and a customer relationship management (CRM) application.

10. The method of claim 1, wherein the analyzing the calendar event data and the stored conference event data comprises:
identifying one or more keywords based on a location, a date, or one or more participants associated with the calendar event data or the stored conference event data; and
selecting the matching custom content from a database based on the keywords.

11. The method of claim 10, wherein the matching custom content comprises one or more of an advertisement, a promotional offer, and a corporate announcement.

12. The method of claim 8, wherein the matching custom content is obtained from one of a social networking site, a search engine, and a third party advertisement platform.

13. The method of claim 8, wherein the matching custom content displayed in the second display portion comprises an image.

14. The method of claim 8, wherein the analyzing the calendar event data and the stored conference event data associated with the user to identify matching custom content comprises:
retrieving a uniform resource locator (URL) from the database.

15. A computer program embodied in a computer-readable medium and executed by a processor, the computer program for providing an integrated calendar/conferencing service, the computer program comprising logic configured to:
launch a mobile application and authenticate a user with a conferencing system via a communication network, the user having a user account comprising conference event data for one or more scheduled online conferences being managed and controlled by the conferencing system;
determine a current portion of the conference event data to be displayed to the user via the mobile application;
send a request to the conferencing system via the communication network for calendar event data associated with the user and corresponding to the current portion of the conference event to be retrieved by the conferencing system from one or more remote applications;
in response to the request, receive from the conferencing system the corresponding calendar event data and targeted presentation content retrieved from a server database, the targeted presentation content selected to match one or more keywords identified from the current portion of the conference event data and the corresponding calendar event data; and
display the current portion of the conference event data and the corresponding calendar event data as an integrated calendar/conference view in a first display portion of the mobile application and simultaneously display the matching targeted presentation content in a second display portion.

16. The computer program of claim 15, further comprising logic configured to:
receive a user selection of one of the scheduled online conferences presented in the first display portion; and
in response to the user selection, initiate the online conference corresponding to the user selection via conferencing system.

17. The computer program of claim 15, wherein the matching targeted presentation content displayed in the second display portion comprises one or more of an advertisement, a promotional offer, and a corporate announcement.

18. The computer program of claim 15, wherein the matching targeted presentation content is obtained from one of a social networking site, a search engine, and a third party advertisement platform.

19. The computer program of claim 15, wherein the matching targeted presentation content displayed in the second display portion comprises an image and a corresponding uniform resource locator (URL).

20. The computer program of claim 15, further comprising logic configured to:
enable the user to navigate the integrated calendar/conference view in the first display portion to view a further portion of the conference event data and the calendar event data;
update the targeted presentation content displayed in the second display portion to match the further portion of the conference event data and the calendar event data displayed in the first display portion.
